(19) United States
(12) Patent Application Publication
(10) Pub. No.: US 2004/0071951 A1
(43) Pub. Date: Apr. 15, 2004

(54) Ultra-high-density information storage media and methods for making the same

(76) Inventor: Sungho Jin, San Diego, CA (US)

Correspondence Address: LOWENSTEIN SANDLER PC, 65 LIVINGSTON AVENUE, ROSELAND, NJ, 07068, US

(21) Appl. No.: 10/262,462

(22) Filed: Sep. 30, 2002

(51) Int. Cl. B32B 3/02

(52) U.S. Cl. 428/323; 428/378

(57) ABSTRACT

In accordance with the invention, a high density recording medium comprises an array of nanomagnets disposed within a matrix of material. The nanomagnets are advantageously substantially perpendicular to a planar surface. The nanomagnets are preferably nanowires of magnetic material or nanotubes filled or coated with magnetic material. Such media can provide ultra-high density recording with bit size less than 50 nm and even less than 20 nm. A variety of techniques are described for making such media.

### FIELD OF THE INVENTION

This invention relates to media for storing information and, in particular, to high-density and mechanically improved information storage media and methods for making the same.

### BACKGROUND OF THE INVENTION

High density information storage, such as magnetic recording and topographic recording, is an important part of modem computer technology. Conventional magnetic recording systems such as computer hard disk drives typically use a continuous magnetic thin film on a rigid substrate as the recording medium. Each bit of information is stored by magnetizing a small area on the magnetic film using a write head that provides a writing magnetic field. The magnetization strength and the location of each magnetic bit should be defined precisely to allow a flying magnetic sensor (read head) to retrieve the written information.

Each magnetic bit in the magnetic recording medium contains one magnetized region that consists of many small magnetized grains. Because of the trend toward higher recording density, the magnetic bit size is continuously being reduced. In order to reduce the size of the magnetic bits while maintaining a satisfactory signal-to-noise ratio, the size of the grains is also being reduced. Unfortunately, substantial reduction of the size of the weakly coupled magnetic grains will make their magnetization unstable due to the superparamagnetic phenomena occurring at ambient operating temperatures.

In order to overcome superparamagnetic limits, patterned magnetic media with discrete magnetic regions have been prepared. See U.S. Pat. No. 5,820,769 to Chou et al., U.S. Pat. No. 5,5587,223 to White et al., and U.S. Pat. No. 6,440,520 B1 to Baglin et al.

In patterned magnetic media, the conventional continuous magnetic film that covers the rigid disk substrate is replaced by an array of discrete magnetic regions, each of which serves as a single magnetic bit. Typical prior art approaches for preparing patterned magnetic media include photolithography, laser interference lithography and electron beam lithography. The lithographic techniques are used to form isolated regions of magnetic material surrounded by areas of non-magnetic material. See C. A. Ross et al., “Micromagnetic behavior of electrodeposited cylinder arrays”, Phy. Rev., Vol. B65, p. 1417 (2002).

Advanced photolithography and laser interference lithography are more convenient than the e-beam lithography. They produce fine, discrete magnetic structures. The bit size, however, is typically larger than ˜100 nm. Hence the magnetic recording density is unduly limited.

Electron beam lithography is capable of producing a finer structure with a bit size as small as ˜10 nm. However, electron beam lithography is a slow, expensive process which is not amenable to industrial mass production.

Desirable nanomagnet arrays can also be obtained using porous anodic alumina membranes containing periodically arranged vertical pores. (The term “nano” as used herein, refers to components having submicron operative dimensions). Cobalt or iron nanomagnet wire arrays so fine as ˜10-15 nm diameter have been obtained by electroplating magnetic metals into such pores. See H. Zeng et al., “Magnetic properties of self-assembled nanowires of varying length and diameter”, J. of Appl. Physics, Vol. 87, p. 4718 (2000), and Y. Peng et al., “Magnetic properties and magnetization reversal of alpha-iron nanowires deposited in alumina film”, J. of Appl. Physics, Vol. 87, p. 7405 (2000). However, the aluminum oxide membrane is a fragile, brittle structure that can easily break or distort from the flat surface required of a magnetic hard disk. The disk must be sufficiently flat that a flying read/write head can slide over it with a gap distance of less than ˜30 nm. Accordingly there is a need for improved high density information recording media and methods for making such media.

### SUMMARY OF THE INVENTION

In accordance with the invention, a high density recording medium comprises an array of nanomagnets disposed within a matrix of material. The nanomagnets are advantageously substantially perpendicular to a planar surface. The nanomagnets are preferably nanowires of magnetic material or nanotubes filled or coated with magnetic material. Such media can provide ultra-high density recording with bit size less than 50 nm and even less than 20 nm. A variety of techniques are described for making such media.

### BRIEF DESCRIPTION OF THE DRAWINGS

The nature, advantages and various additional features of the invention will appear more fully upon consideration of the illustrative embodiments now to be described in detail with the accompanying drawings. In the drawings:

FIG. 1 schematically illustrates a first embodiment of an improved magnetic recording medium in accordance with the invention;

FIG. 2 is a schematic block diagram of a first method of making the medium of FIG. 1;

FIG. 3 schematically illustrates the magnetic recording medium at various stages of the process of FIG. 2;

FIG. 4 schematically illustrates an alternative ultra-high-density magnetic recording media and fabrication processes according to the invention;

FIG. 5 schematically illustrates an alternative ultra-high-density magnetic recording media and fabrication processes according to the invention;

FIG. 6 schematically illustrates an alternative ultra-high-density magnetic recording media and fabrication processes according to the invention;

FIG. 7 schematically illustrates processing steps to prepare nanomagnet array magnetic recording media structure by phase decomposition, uniaxial deformation and slicing of two-phase bulk alloy material according to the invention;

FIG. 8 schematically illustrates structure and processes to obtain a textured ultra-high-density magnetic recording medium by differential etching of aligned nano-composite according to the invention;

FIG. 9 illustrates processing steps to obtain topographically defined ultra-high-density CD-ROM recording media by differential etching of two-phase nano-composite structure according to the invention; and,

FIG. 10 schematically illustrates topographically defined ultra-high-density CD-ROM recording media structure by differential additive process according to the invention.

FIGS. 11 schematically illustrates apparatus for providing a two-dimensional array of electron beams useful in the fabrication of ultra-high-density magnetic recording media according to the invention;

It is to be understood that these are for the purpose of illustrating the concepts of the invention and are not to scale.

### DETAILED DESCRIPTION OF THE INVENTION

This invention describes the structure and fabrication of recording media particularly useful for ultra-high-density recording. By “ultra-high-density recording”, is meant recording at 50-nanometer information bit size or less, and preferentially 20 nanometer bit size or less.

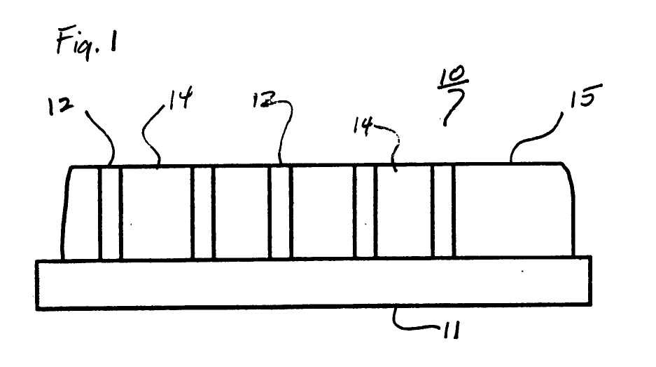

Referring to the drawings, FIG. 1 illustrates an exemplary magnetic recording medium 10 comprising a substrate 11, a plurality of magnetic nanowires 12 disposed substantially perpendicular to the substrate and a nonmagnetic filler material 14 disposed in spaces between the magnetic nanowires. (The term “nanowires” is used herein generically to encompass both true nanowires (solid cores) and nanotubes (hollow cores)). The magnetic nanowires 12 can comprise nanowires of magnetic material or nonmagnetic nanowires, such as carbon nanotubes, nanosilicon fibers, or nanometal wires, that are coated with magnetic material. It can also include nanotubes that are filled with magnetic material. The medium 10 is advantageously provided with a planarized surface 15 substantially perpendicular to nanowires 12. Preferably the nanowires are arranged in a substantially regular array.

In this embodiment, the conventional magnetic disk material comprising a continuous magnetic film is no longer utilized. Instead, a plurality of discrete, nanoscale magnetic elements are employed to overcome the superparamagnetic limits in recording density. Each discrete magnetic element, or several elements as a block, can be magnetized along the same direction, thus constituting a magnetic bit. Each of the elements are preferably separated from other elements by a nonmagnetic matrix material. The inter-element spacing is kept large enough to minimize exchange interaction between neighboring elements. Each magnetic element preferably has the same size and shape, and is made of the same magnetic materials.

The elements are preferably regularly arranged on the substrate, although it is not an absolute requirement where plural elements are magnetized and used as a single bit. Each magnetic element has a small size and a preferred shape anisotropy so that, the magnetization of each discrete magnetic element will be automatically aligned along the long axis of the anistropic element. This means that the magnetic moments of each nano-scale discrete magnetic element is quantized and has only two states with the same magnitude but two opposite directions. Such a discrete magnetic element can be a single magnetic domain. Each direction of a quantized magnetic moment represents one value of a binary bit. A magnetic recording (or writing) operation involves flipping the magnetic moment direction of the single domain element. A reading operation involves sensing the quantized magnetic moments. The moments are preferably oriented perpendicular to the medium surface rather than longitudinally along the surface. A magnetic storage system, such as a hard disk system in a computer, consists of the magnetic storage medium, write heads, and read heads.

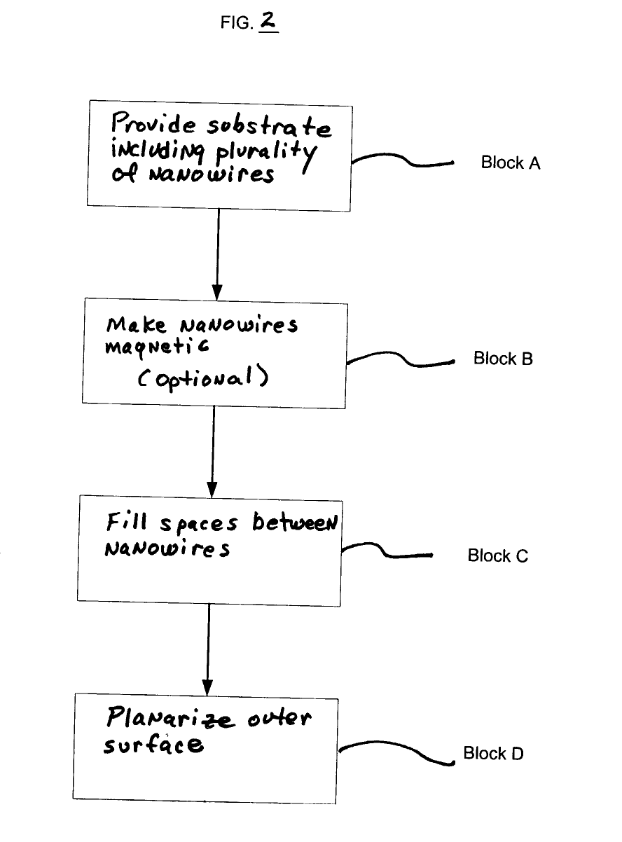

FIG. 2 is a schematic block diagram of an exemplary process of making the magnetic recording medium of FIG. 1. The first step, shown in Block A, is to provide a substrate having a plurality of nanowires disposed substantially perpendicular to a surface. Advantageously the nanowires are secured to the surface in a substantially regular (approximately regularly or periodically spaced) array.

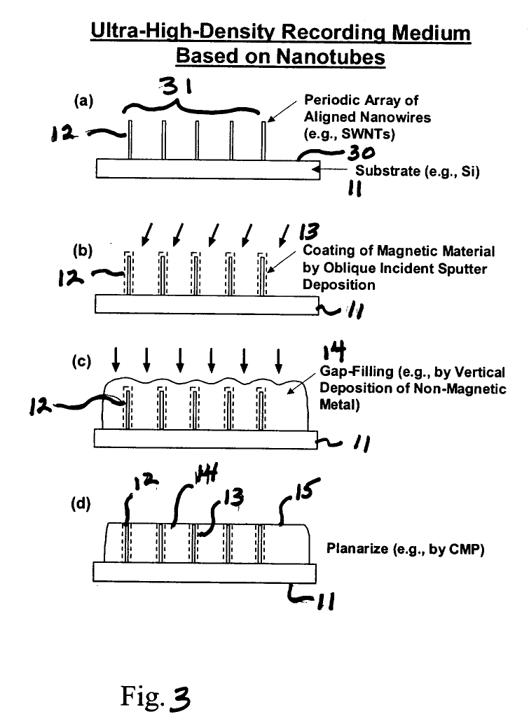

FIG. 3A illustrates such a substrate 11 advantageously having a flat surface 30 supporting an array 31 of nanowires 12. Advantageously the array can be periodic in one or two dimensions. The substrate 11 is advantageously silicon, metal or ceramic. The nanowires 12 can be magnetic or nonmagnetic. Advantageously the nanowires comprise vertically aligned single wall nanotubes (SWNT) with diameters in the range of about 1-1.6 nm or multiwalled nanotubes (MWNT) with diameters of about 5-50 nm. Such arrays can be grown by microwave plasma enhanced chemical vapor deposition (MPECVD) as described in Bower et al., Applied Physics Letters, Vol. 77, p. 830 (2000).

If the nanowires are nonmagnetic, then the second step (Block B of FIG. 2) is to make them magnetic. In order to provide magnetism to non-magnetic nanowires, the surface of nanowires can be coated with magnetic material. A preferred coating process uses inclined-angle, physical vapor deposition such as sputtering , evaporation, or laser ablation. Standard physical vapor deposition, which is typically carried out perpendicular to the substrate, is less preferable as the deposited material would mostly go to the tips of the nanowires instead of the intended side walls. The angle of inclined deposition is advantageously selected so that substantial deposition occurs on the side walls.

FIG. 3B illustrates the substrate-supported array of nanowires 12 being coated with magnetic material 13 by inclined angle deposition. The desired range of inclined angle depends on the height and the spacing between the nanowires. The shadow effect is to be minimized. The inclination is typically in the range of 2 to 70 degrees and preferably in the range of 5 to 45 degrees. It is also preferred that either the substrate or the deposition source be rotated such that all sides of the nanowires are coated. The coating need not extend the whole length of the nanowires, as the magnetizing of information bit near the top end of the coated nanowires is more important. However, it is desired to have at least the upper 30% and preferably at least the upper 60% of the nanowire length coated. The magnetic material can be selected from known magnetic materials such as Ni, Fe, Co, their alloys, and ferrite- or perovskite-based compounds.

Chemical vapor deposition (CVD) of the magnetic coating is also possible. A care must be taken as the conformal nature of CVD deposition is likely to result in deposition of the magnetic material on the substrate surface and, without careful control, may cause magnetic shorting of adjacent nanomagnet wires. A CVD deposition with preferential or differential deposition rate in favor of the nanowire surface can minimize such a concern. Electrodeposition may also be used but electrodeposition is a more complicated and care is required to avoid damaging the delicate nanowires during insertion into and removal from the aqueous electrolyte solution.

In an alternative inventive configuration, nanotubes, instead of being coated, can be filled with magnetic material. Such nanotubes filled with a magnetic material such as Ni have been reported, albeit without the desired alignment, by N. Grobert et al., Appl. Phys. Vol. A67, page 595 (1998), and by M. Terrones et al. in MRS Bulletin, August 1999 issue, page 43. The desired aligned and metal-filled carbon nanotubes can be obtained by control of nucleation and growth on a flat substrate to co-deposit metal and carbon nanotube simultaneously. The alignment can be accomplished by applying electric or magnetic field. In such a filled configuration, the diameter of nanomagnets can be even smaller and a higher density of magnetic recording can thus be accomplished. However, too small a diameter may not be desirable because of the onset of superparamagnetic behavior. The magnetic metal filling inside a tube-shaped, non-magnetic nano material (not necessarily carbon nanotubes) desirably has a diameter of at least 0.5 nanometer, preferably at least 1 nanometer, even more preferably at least 3 nm.

In the third step, Block C of FIG. 2, the gap between the nanowires is filled by a non-magnetic filler material, such as metal, alloy or a non-magnetic compound. This can be accomplished by physical vapor deposition (e.g. sputtering, evaporation or laser ablation) from a direction perpendicular to the substrate. The filler material can be chosen from a number of well known non-magnetic materials, such as Al, Ti, Si, Cu, Mo, Cr or their alloys, or their non-magnetic oxides, carbides, nitrides, silicides, or borides. It is preferred that the filler material has high mechanical hardness so that the finished recording media has wear resistance on the surface. The preferred microhardness value of the inventive recording media is at least 500 Kg/mm² and preferably at least 1000 Kg/mm² as measured by Vickers or Knoop indentation. As a reference, the microhardness of pure copper is on the order of ˜100 Kg/mm² and that of silicon nitride is ˜1500 Kg/mm².

FIG. 3C illustrates the workpiece during the disposition of filler material 14 between the magnetized nanowires 12.

In the final step, Block D of FIG. 2, the outer surface of the gap-filled composite structure is planarized, as by known mechanical polishing techniques or chemical mechanical polishing (CMP).

The resulting magnetic storage medium is shown in FIG. 3D with surface 15 planarized. In this final product, the magnetic material can be in the form of a cylindrical coating 13 around the nanowires 12 rather than a solid magnetic rod. The cylindrical structure sacrifices some volume of magnetic material, but enhances the aspect ratio of elongation in the magnetic material, thereby minimizing undesirable self demagnetizing. The desired range of nanomagnet diameter (outside diameter of the magnetic cylinder) is less than 100 nm, preferably less than 20 nm and even more preferably less than 10 nm. The desired height of the nanomagnet cylinder is advantageously in the range of 10-5000 nm, and preferably 50-500 nm. With the 10 nm size magnetic bit dimension corresponding to each of the nanomagnets present in the recording medium, the recording density is ˜10¹² or ˜1 terabits/square inch. The availability of such an ultra-high-density recording medium will be very useful in advancing information storage and management technologies.

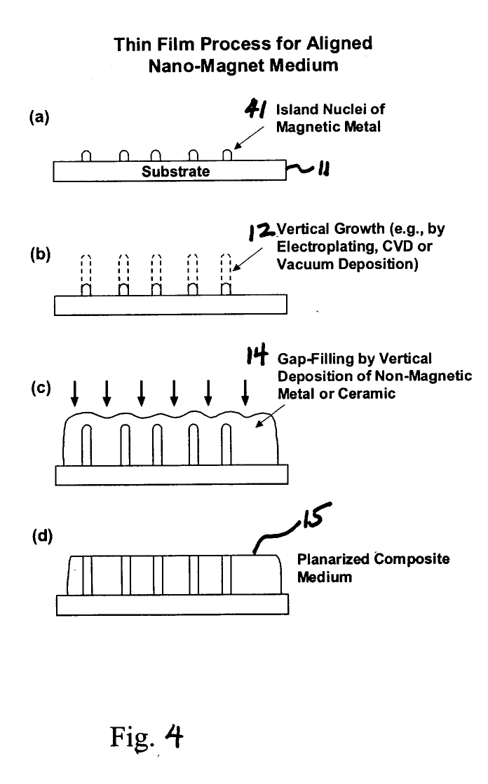

FIG. 4 illustrates an alternative method of fabricating the magnetic recording media of FIG. 1. The first step (FIG. 4(a)) is to introduce on substrate 11 island nuclei 41 for growing nanowires comprising magnetic material with preferred diameters of less than 100 nm, preferably less than 20 nm, and even more preferably less than 10 nm.

Accurate, two-dimensional and economical nano patterning of such islands can conveniently obtained by using the two-dimensional electron beam lithography technique or the x-ray lithography technique, described in a provisional patent application Serial No. 60/405,561 entitled “MEMS-Based Two-dimensionalE-Beam Nano LithographyDevice and Method for Making the Same”, filed by S. Jin on Aug. 23, 2002, which is incorporated herein by reference. The e-beams or x-ray beams are maneuverable either by MEMS operation or by electrostatic beam guiding operation, thus allowing nano patterning in a two-dimensional fashion without an excessive number of electron guns.

To make the islands, the substrate is coated with resist. Using lithography, the resist is patterned in a nano array of circles or other closed shapes and developed. The resulting holes are filled with magnetic material as by covering the entire surface of the resist with magnetic material and lifting off the resist to remove the excess of magnetic material on the resist while leaving the magnetic material in the holes.

In the next step, FIG. 4(B), the islands 41 of magnetic material (such as Co, Fe, Ni) are made to grow along the vertical axis to form long and aligned nanomagnets 12. Electroplating or CVD deposition can be used to form the elongated magnets 12.

In FIG. 4(C), the gap spacings between the nanomagnets are then filled with non-magnetic filler material 14 such Al, Ti, Si, Cu, Mo, Cr, their alloys, or their non-magnetic oxides, carbides, nitrides, silicides, borides, or polymer-based material. Typically the deposition is by physical vapor deposition, chemical vapor deposition or electrodeposition.

In the final step, FIG. 4(D), the outer surface 15 of the gap-filled composite structure is planarized. High microhardness on the polished surface of the medium is desirable.

The desired range of nanomagnet diameter is less than 100 nm, preferably less than 20 nm, even more preferably less than 10 nm. The desired height of the nanomagnet cylinder is in the range of 10-5000 nm, preferably 50-500 nm. With the 10 nm size magnetic bit dimension corresponding to each of the nanomagnets present in the recording medium, the recording density is ˜10¹² or 1 terabits/square inch.

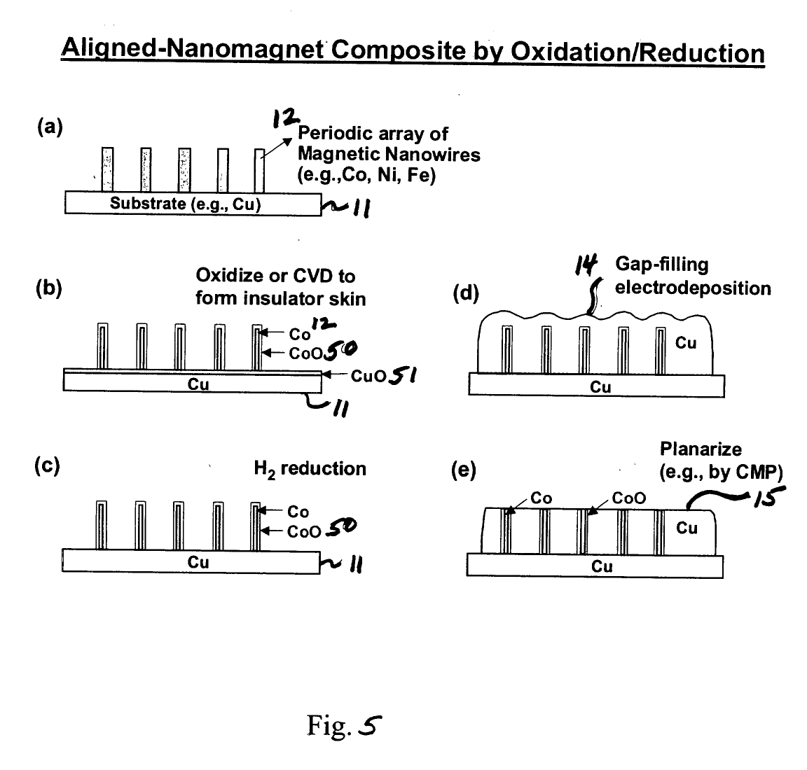

Another alternative process of making ultra-high-density magnetic recording media is shown in FIG. 5. In the first step, FIG. 5(A), an array of magnetic nanowires 12 (periodic or random) is formed on a substrate 11 that oxidizes or reduces easily, such as copper.

As a second step, shown in FIG. 5(B), these nanowires 12 are then provided with an oxidized surface 50 as by heating in an oxygen-containing atmosphere. The oxidation also serves to decrease the diameter of the magnetic core. Exemplary processing is to heat at 400-700° C. for 0.1-10 minutes in air or oxygen. The top surface of the copper substrate also is oxidized to an oxide coating 51.

In the next step, FIG. 5(C), the whole structured is subjected to a reduction treatment as by heating in hydrogen-containing atmosphere (e.g., heating at 250-350° C. for 1-100 minutes in pure hydrogen or a hydrogen/nitrogen atmosphere). While Cu-oxide is relatively easily reduced to metallic Cu at this low temperature, Co-oxide remains oxidized as it requires a much higher temperature to be reduced by H₂ reduction. So the workpiece with the magnetic nanowires coated with insulating oxide skin 50 now allows a gap-filling electroplating of filler material 14 (e.g., Cu) to be carried out in an efficient manner (FIG. 5(D)) without causing undesirable electrodeposition to take place preferentially at the tips of nanowires. Without the protection of the Co-oxide skin, mostly the Co nanowire would have become longer with added Cu electrodeposit material without efficient filling of the gap with Cu. The structure of FIG. 5(D) is then polished to a flat surface 15 to have the final configuration of FIG. 5(E).

The desired range of nanomagnet diameter is less than 100 nm, preferably less than 20 nm, and even more preferably less than 10 nm. The desired height of the nanomagnet cylinder is in the range of 10-5000 nm, preferably 50-500 nm.

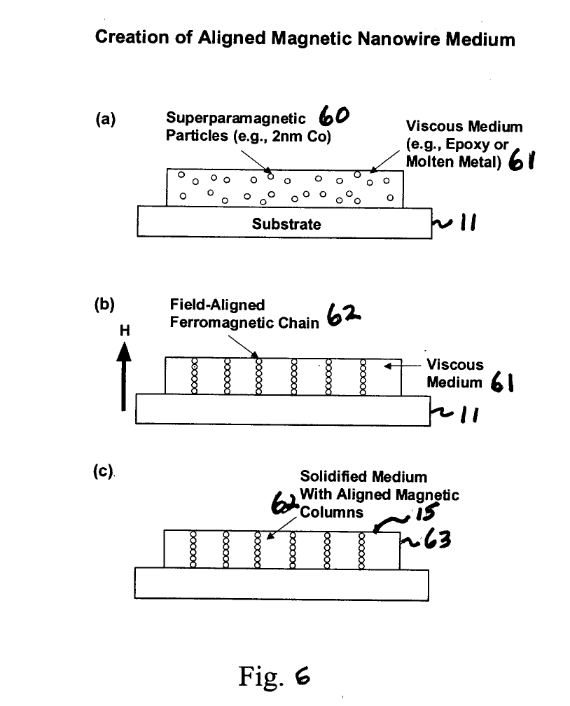

An entirely different approach to fabricating the ultra-high-density magnetic recording media is illustrated in FIG. 6A. In this approach, nanoscale superparamagnetic particles 60 dispersed in a viscous medium 61 are maneuvered to form a desired chain structure suitable for high-density magnetic recording. While nano-size ferromagnetic particles (for example, 10-30 nm diameter cobalt or iron particles) tend to clump by magnetic interactions, very fine magnetic particles (e.g., less than ˜3 nanometers in diameter) are superparamagnetic and do not clump. Their magnetic moment is not stable at ambient temperature because of thermal excitation, and hence they are superparamagnetic with no remnant magnetization, rather than being ferromagnetic. The superparamagnetic particles 60 thus do not clump, and remain randomly dispersed in a viscous medium as illustrated in FIG. 6A.

The next step, shown in FIG. 6B, is to apply a magnetic field to the workpiece to line up the particles 60. The superparamagnetic particles 60 line up into parallel chains-of-spheres 62 along the direction of the applied field. As the superparamagnetic behavior is reduced with increasing volume of magnetic material, each chain-of-sphere structure tends to behave as a ferromagnet. When the matrix viscous medium (such as epoxy, polyamide, or molten metal) is cured (e.g., by heating to 100-150° C. for 10 minutes) or solidified, the aligned nanomagnet chain structure is permanently retained. With appropriate polishing of surface 15 (if needed), the cured medium 63 of FIG. 6(C) can serve as an ultra-high-density magnetic recording medium.

The desired range of diameter of the nanomagnet chain is less than 20 nm, preferably less than 10 nm, and even more preferably less than 5 nm. This value is also dependent on the nature of their magnetic material used in the chain structure, as different materials may have different critical dimensions to switch from ferromagnetic to superparamagnetic behavior. With the 10 nm size magnetic bit dimension corresponding to each of the nanomagnets present in the inventive recording medium, the recording density is calculated to be about 1 terabit/square inch. With 5 nm diameter, a recording density of ˜2.5 terabits/square inch is estimated.

Yet another approach of making an ultra-high-density magnetic recording medium is to use phase transformation. This approach utilizes specially fabricated, fine-scale, multi-phase (e.g., two-phase decomposed) alloy systems in order to provide desirable, parallel aligned nano-magnet phase regions supported by a surrounding non-magnetic or less magnetic phase. According to one aspect of the invention, such a fine-scale structure is mechanically sectioned or surface-ground to reveal the cross section of the aligned nanomagnets for small bit size magnetic recording.

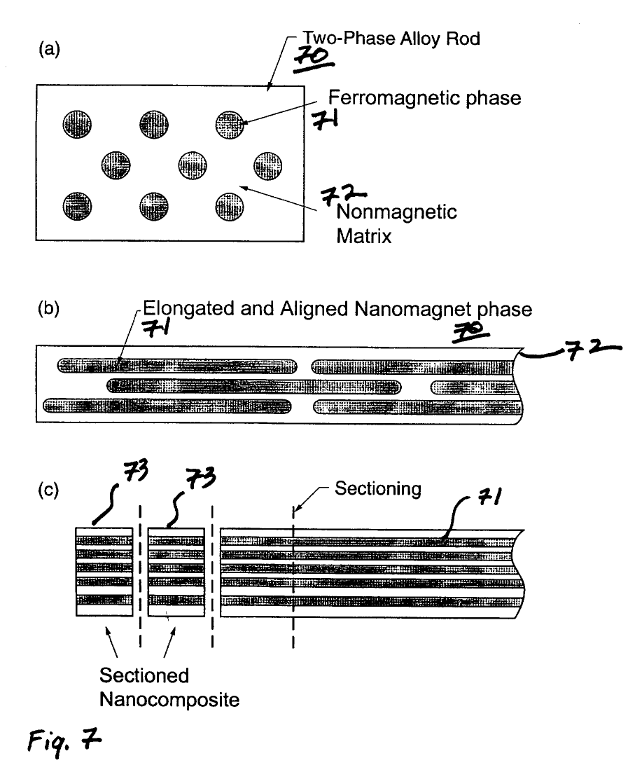

FIG. 7 schematically illustrates an exemplary phase transformation process of obtaining a recording medium comprising aligned and reduced-diameter carbon nanotubes. FIG. 7A represents a phase-separated structure 70 formed by heat treating nucleation & growth (N&G) type alloys or spinodal type alloys inside a miscibility gap. The structure 70 comprises ferromagnetic phase regions 71 within a nonmagnetic matrix 72. The desired average particle size of the ferromagnetic phase regions 71 at this stage of the processing is typically in the range of 2-200 nm, and preferably in the range of 2-50 nm.

The phase separated structure 70 is then uniaxially and plastically deformed, e.g., by extrusion, swaging, rod drawing, or wire drawing process to elongate and at the same time reduce the diameter of the ferromagnetic phase. The resulting structure is schematically illustrated in FIG. 7B. For example, an extrusion/wire drawing of a 20 cm diameter rod into a 2 cm diameter rod will make the initially 50 nm diameter spherical particles to be elongated into 5 nm diameter fibers and 8000 nm long, with a very large length-to-diameter aspect ratio of 8000. The desired amount of deformation to be given to the alloy is of course selected based on the final diameter of the ferromagnetic desired, but is typically in the range of 50-99.99% reduction in cross-sectional area of the alloy. The deformed alloy rods or wires can optionally be bundled together, placed in a jacket, and subjected to additional deformation to further reduce the diameter of the magnetic phase. Instead of or in combination with the uniaxial deformation, a planar-type deformation such as by cold rolling, hot rolling, compression deformation may also be used. In this case, the magnetic phase particle will have a ribbon shape morphology rather than a fiber-shape morphology. The deformed and elongated alloy structure 70 may be bundled together and subjected to further uniaxial deformation to further reduce the diameter of the catalytic phase.

The elongated and aligned structure can then be separated, as by cutting, into sections 73 of desired thickness, as shown in FIG. 7C, and polished smooth. Because of the very large aspect ratio of the magnetic phase in the fiber configuration, a cross-section from any location along the rod length tends to give essentially identical and reproducible microstructure, especially in the case of periodic spinodal structure, with essentially the same number of exposed nanomagnets on various sectioned surfaces. Such sections 73 are desirable for ultra-high-density magnetic recording.

The desired final diameter of the aligned ferromagnetic phase on the alloy substrate is typically less than 50 nm, preferably less than 20 nm, even more preferably less than 10 nm. The desired height of the nanomagnet cylinder is in the range of 10-5000 nm, preferably 50-500 nm. With the 10 nm size magnetic bit dimension corresponding to each of the nanomagnets present in the inventive recording medium, the recording density is ˜10¹² or ˜1 terabits/square inch.

This particular fabrication process is advantageous in that it is based on bulk processing, and can even be carried out without sophisticated thin film, vacuum, or clean room processing. The extruded composite rod only needs to be sliced and polished into recording media wafers, desirably with the disk thickness in the range of, for example, 0.1-5 mm. The availability of such inexpensive, ultra-high-density, recording medium will be very useful in advancing information storage and management technologies.

Preferred alloy systems contain at least one ferromagnetic metal such as Fe, Ni, or Co. The preferred alloy systems to create such nano-scale aligned structure include alloys which can be solid solution annealed at a high temperature, e.g., above ˜500° C. and then can be solid-state transformed into the desired two- or multi-phase structure, e.g., by heat treatment at a lower temperature.

The formation of the ultra-high-density nanomagnet structure in these alloy systems can be accomplished either by nucleation-and-growth (N&G) phase transformation such as precipitation or GP zone formation or by spinodal decomposition. Spinodal decomposition is one way of achieving a phase separation within a miscibility gap. The growth of compositional modulation occurs gradually from an initially homogeneous solution. Because of the periodic and sinusoidal nature of the compositional fluctuation at the early stage of spinodal decomposition, the particle size of the decomposed phase is commonly described in terms of the “wavelength” and the compositional difference between the two phases in terms of the “amplitude”. See J. W. Cahn, Acta Met., Vol. 10, p. 179, 1962. Unlike the nucleation-and-growth transformation, any compositional fluctuation in spinodal decomposition always lowers the free energy of the alloy system. Therefore, spinodal decomposition occurs spontaneously without having to overcome a nucleation barrier, and the resultant wavelength (or the particle size) is generally much smaller and much more uniform than in the N&G transformation. This uniformity in particle size as well as the small particle size are particularly useful in making an array of nano-magnets.

Depending on the alloy system and the nature of the heat treatment given to induce the phase separation, the particle size obtained from both N&G and spinodal mechanisms can be small, often less than ˜10 nm level. Both types of alloy systems can be used as the basis of the present inventive process, although spinodal systems are more advantageous if a uniformity in nanotube diameter is desired. Examples of N&G type alloys which are suitable for providing elongated nanomagnets separated by non-magnetic or weakly magnetic phase include alloy systems comprising the magnetic elements such as Fe, Co, or Ni together with non-magnetic elements such as Cu or Cr. These alloy systems should exhibit decreasing solubility of the catalyst element with decreasing temperature so that precipitation-type phase segregation becomes possible. The alloy compositions in the N&G regime of the spinodally decomposable systems as listed below are also suitable to produce the N&G type alloy substrate. Additional alloying elements may optionally be added to these alloy systems, with each element less than 5 weight %, and all the alloying elements together less than 30%.

Examples of N&G type alloys include alloy systems comprising the ferromagnetic elements such as Fe, Co, or Ni together with nonmagnetic elements such as Cu or Cr. These alloy systems should exhibit decreasing solubility of the magnetic element with decreasing temperature so that precipitation-type phase segregation becomes possible. Fe—Cu, Co—Cu alloys as well as the alloy compositions in the N&G regime of the spinodally decomposable systems as listed below are also suitable to produce the N&G type alloy substrate. Additional alloying elements may optionally be added to these alloy systems, with each element less than 5 weight %, and all the alloying elements together less than 30%. Alternatively, a use of composite structure may also be considered. For example, a rod of Cu with longitudinal holes filled with an array of Fe rods can be extruded/wire-drawn, repeatedly by re-bundling or in-between annealing to soften the material for additional uniaxial deformation if needed, to form a composite material containing aligned nanomagnetic filaments. This can be sectioned to obtain a disk with an array of nanomagnets. One drawback of this composite approach, however, is that the amount of plastic deformation required is much more than the case of two-phase structure where the starting size of the ferromagnetic phase is typically less than 100 nm in diameter.

Examples of the spinodal alloy systems that can produce, according to the invention, aligned nanomagnet structure include Fe-Cr with a composition in the spinodal range (e.g., ˜35-65 wt % Cr), Fe—Cr—Co (20-65% Cr, 1-30% Co, and the balance Fe), Cu—Ni—Fe (˜15-40% Ni, 15-30% Fe, and the balance Cu) and Cu—Ni—Co (˜20-40% Ni, 20-40% Co, and the balance Cu). These alloys may optionally contain other alloying elements each less than 5%, and all together less than 30%.

As a specific example, nano-scale elongated and aligned two-phase structure is obtained in an Fe-33Cr-7Co-2Cu alloy by the following process. The alloy is given an initial spinodal decomposition heat treatment, after solution annealing at ˜660° C. by continuous cooling to 595° C. at a rate of 7° C./hr and water quenched. The structure thus obtained contains near-spherical (Fe,Co)-rich phase with ˜40 nm in diameter distributed inside the Cr-rich matrix. After uniaxial deformation by wire drawing by 99% reduction in cross-sectional area (alloy rod diameter reduction by a factor of 10), the (Fe,Co)-rich particles are elongated with an aspect ratio of ˜1000, and their diameter reduced from ˜40 nm to ˜4 nm. The deformed alloy is typically given additional low temperature heat treatment to further build up the compositional amplitude. Processing details for the Fe—Cr—Co spinodally decomposing alloys are given in publications by S. Jin et al., IEEE Trans. Magnetics, Vol. MAG-16, p. 1050, 1980, and IEEE Trans. Magnetics, Vol. MAG-23, p. 3187, 1987. Another suitable alloy system for producing the aligned nanomagnet magnetic recording media is Cu—Ni—Fe alloy system, for example, 60% Cu, 20% Ni and 20% Fe. The spinodally decomposed Cu—Ni—Fe alloys are ductile enough to do extrude type uniaxial plastic deformation to elongate the structure.

In operation of modem magnetic recording systems, the read/write head often glides over the surface of a magnetic disk on an air bearing (a layer of air which moves together with the rotating disk). Thus, the glide height between the read/write head and recording surface depends in part on the surface topology of the magnetic disk. The reliability of magnetic recording systems often improves with increased surface roughness on the magnetic disk as smooth surfaces do not easily build up the moving layer of air over the disk's surface required to fly the head. The problem of stiction or the frictional contact between the head and rotating disk caused by insufficient air bearing (or insufficient lubricant) thus has a profound impact on the durability of magnetic recording media. In order to minimize such a problem, surface roughening or texturing of magnetic disk surface has been employed. See U.S. Pat. No. 6,350,178 B2 to Weiss et al., issued Feb. 26, 2002.

According to the further embodiment of the invention, the aligned nano-composite structures described herein can further be modified by controlled etching or plating to create a surface textured magnetic recording medium with improved mechanical durability and reduced probability of head-media stiction.

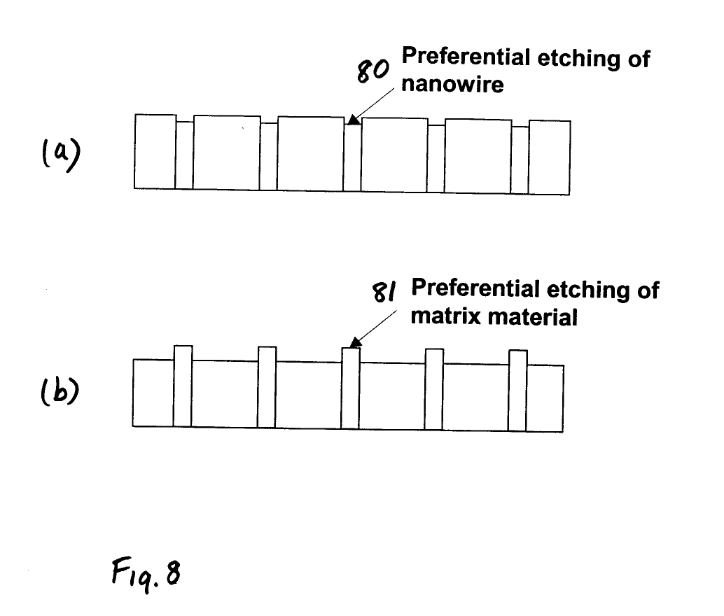

The etching can be done by using chemical etching, electrochemical etching, or other etching processes such as plasma etch, ion beam etch, and laser ablation. Because the two phases in the composite or phase-separated structure have different composition, the two phases exhibit different etch rates to various etch mechanisms. For example, in the two-phase nanostructure of FIG. 7, the Fe-rich phase in the Fe—Cr alloy system is dissolved much faster by acid than the Cr-rich matrix phase surrounding the Fe-rich phase fibers. Hence an aligned and recessed readable bits can be created. FIG. 8A illustrates such a medium etched to produce recessed nanomagnets 80 which can be bits or portions thereof.

In the case of a Cu—Fe or Cu—Ni—Fe alloy system, however, the Fe-rich phase dissolves slower in certain acids than the Cu-rich matrix phase, and hence a protruding, rather than recessed bit configuration will be obtained. Likewise, with chemical etching of the nano-composite structure of FIG. 5 a nano protrusion bit structure can be obtained. FIG. 8B shows an exemplary medium with protruding nanomagnets 81 which can be bits or portions thereof.

Depending on the particular nano-composite structure the chemical properties of each of the materials or phases involved, and the differential etching chemicals or electroplating techniques employed, either the subtractive or the additive process may be used to create the aligned nano-protrusion or nano-recession bit structure, which can also be utilized as a textured surface to enhance the mechanical durability of magnetic recording system with minimal head-media stiction or crash problems.

Another type of recording media widely used for mass information storage is compact disc (CD) and DVD discs. The CDs have been used mostly for read-only memory (ROM) applications, although a rapid progress is being made in the use of write-able CD disc memory technology. Commercially available CDs are usually made of ˜1 mm thick plastic coated with an aluminum layer and a protective plastic coating. The CD contains microscopic bumps or recessed holes arranged as a single or continuous spiral track of data. As the CD disc is rotated in the CD player, a laser beam focused by a lens system follows the spiral track and reads the presence or absence of the bumps. As the bit size in the current CDs is typically larger than about 200 nm, the recording density is less than a few gigabits per square inch.

According to a modified embodiment of the invention, the capacity of information storage density in compact disc media can be increased significantly by orders of magnitude. The information bit size of bumps or recessed holes on CD surface can be made to be extremely fine, for example, of the order of 10 to 50 nm in diameter, giving rise to a recording density of about 40 gigabits to 1 terabit per square inch. The laser optical technique currently available can no longer effectively detect such fine nanoscale features which is well below the wavelengths of the laser beam used. New techniques which can allow the reading of such nanoscale information bits on ultra-high-density CD discs are disclosed in U.S. patent application Ser. No. ______ by S. Jin entitled “Read Head For Ultra-High-Density Information Storage Media and Method For Making Same”, filed Sep. 30, 2002, which is incorporated heerein by reference.

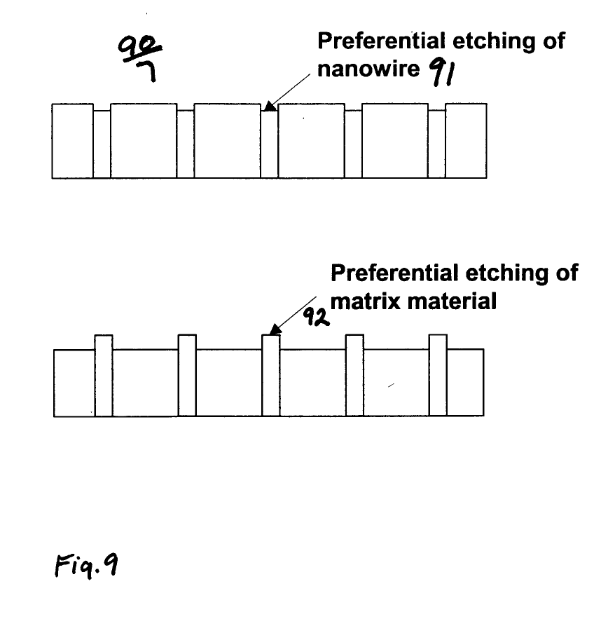

The vertically aligned nano-composite structures described in herein can be modified by controlled etching or plating processes to create an ultra-high-density CD-ROM (compact disk-read only memory) medium. As illustrated in FIG. 9A, a nano-composite structure 90 can be etched to create a recessed or protruding array of nanoscale information bits 91 which can be interrogated and read by CD-ROM reader. The etching can be done by using chemical etching, electrochemical etching, or other etching processes such as plasma etch, ion beam etch, and laser ablation. Because the two phases in the inventive composite or phase-separated structure have different material or composition and hence different etch rate to various etch mechanisms.

For the examplary case of the two-phase nanostructure, the Fe-rich phase in the Fe—Cr alloy system is dissolved much faster by acid than the Cr-rich matrix phase surrounding the Fe-rich phase fibers, and hence an aligned and recessed readable bit structure is created. In the case of Cu—Fe or Cu—Ni—Fe alloy system, however, the Fe-rich phase dissolves slower in certain acids than the Cu-rich matrix phase, and hence a protruding, rather than recessed bit configuration will be obtained. Likewise, chemical etching of the nano-composite structure of FIG. 5 will result in a nano protrusion bit structure.

The desired range of information bit in the inventive CD-ROM nano-composite medium is less than 100 nm, preferably less than 20 nm, even more preferably less than 10 nm. With the 10 nm size bit dimension corresponding to each of the nanowire present in the inventive recording medium, the recording density is calculated to be an astounding ˜10¹² or ˜1 terabits/square inch. The availability of such an ultra-high-density CD-ROM recording medium will be very useful in advancing information storage and management technologies, as the currently commercially available CD-ROM density is one to two orders of magnitude lower than is possible with this inventive CD-ROM medium. The desired height of the nanowire cylinder is in the range 10-5000 nm, and preferably 50-500 nm.

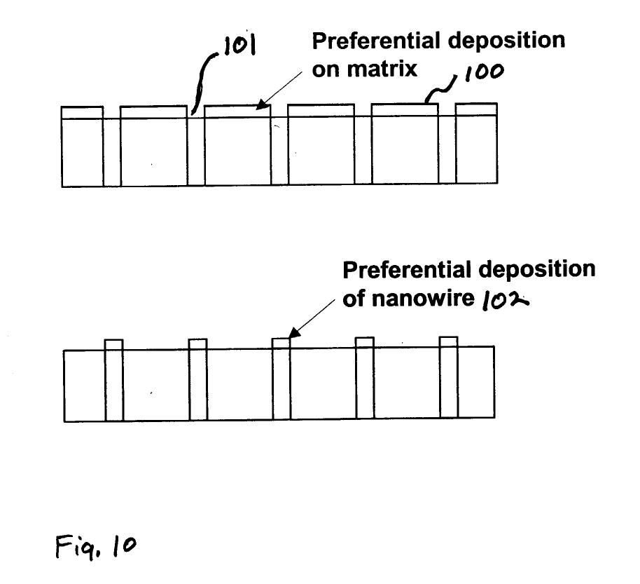

In yet another alternative inventive processing method, an additive process of electroplating or electroless plating may be utilized, as illustrated schematically in FIG. 10. For example, if Cu 100 plating is used on the nano-composite structures of FIG. 5 or the Cu atoms tend to preferentially attach onto the Cu-rich matrix phase, thus creating the desired recessed bit structure 101 shown in FIG. 10A. Alternatively, in the absence of a preferential coating, material can be preferentially deposited on the nanomagnets 12 to create a protruding bit structure 102 (FIG. 10B). Depending on the particular nano-composite structure, the chemical properties of each of the materials or phases involved, and the differential etching chemicals or mechanism employed, either the subtractive or the additive process may be used to create the aligned nano-protrusion or nano-recession bit structure.

Once the array of nanoscale elements is fabricated on the disc, data can be written on to the CD by the read-write head disclosed in application Ser. No. ______ by S. Jin entitled “Read Head For Ultra-High-Density Information Storage Media and Method For Making Same”, filed Sep. 30, 2002. The array of indentations, or projections above the surface is important in nanostructure CDs to establish the grid of where data can be written. The grid forces the location of data bits and minimizes analog location errors. Data may be written to groups of elements in the array (where several grid positions, 6 for example, are assigned to each bit), or data bits can be written as one bit per one grid element.

The writing process is done by directing the e-beam of the wire head to ablate the surface. Because the materials that make up the nano elements and the material filling the spaces between the nano elements have different properties, they ablate, or evaporate away on heating at different rates. This is advantageous because such characteristics aids in writing the bit structure with a better-defined geometry than in the case of writing on a homogeneous material. Therefore by aiming a write head e-beam of suitable intensity at a group of array elements, or more finely at a single element, the ablation process produces a clearly defined “0” or “1” data bit by removing the nano feature by creating a localized smooth surface or by leaving the localized structures intact. The encoded areas can then be read by the x-ray read head as disclosed in the above mentioned co-pending application.

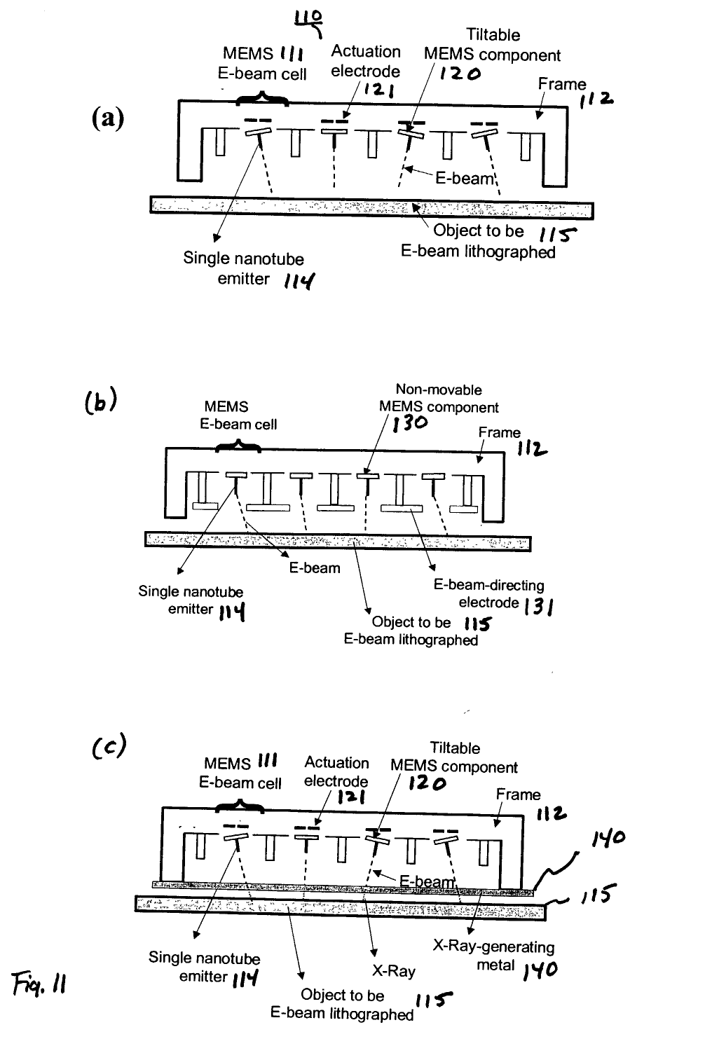

FIGS. 11A, 11B and 11C illustrate two-dimensional e-beam lithography devices useful in making the recording media described herein and implementing the process described. In essence, each two-dimensional e-beam device 110 comprises an array of MEMs e-beam cells 111 within a frame 112. Each cell contains a movable or scannable component with a single electron field emitter 114 such as a carbon nanotube. Each electron beam from the respective emitters can be directed (independently if desired) to scan a desired location on an underlying workpiece 115 to be patterned or etched. In FIG. 11A, the emitters are disposed on a tiltable MEMs component 120 whose tilt is controlled by an actuation electrode 121.

In FIG. 11B, the emitters are dispersed on a stationary MEMs component 130 and the e-beams are controlled by e-beam directing electrodes 131. In FIG. 11C, an x-ray generating foil 140 is disposed between the emitter and the workpiece 115 to expose local regions to x-rays. Further details concerning these two-dimensional e-beam devices is set forth in applicant's copending application Ser. No. 60/405,561 incorporated herein by reference.

As applied to the fabrication of recording media, the above lithographic apparatus permits economical patterning of workpieces 115 to form holes for the deposition of nanowire nuclei, the selective etching of areas containing bits for recording and the formation of patterns of bits using lithographic processes as described herein.

It is understood that the above-described embodiments are illustrative of only a few of the many possible specific embodiments which can represent applications of the invention. Numerous and varied other arrangements can be made by those skilled in the art without departing from the spirit and scope of the invention.

We claim:

1. A high density magnetic recording medium comprising:
a substrate supporting a plurality of magnetic elements comprising nanowires or nanotubes disposed on the substrate in an array with spaces between the elements,
a filler material of nonmagnetic material disposed in the spaces between the magnetic elements, the filler material having a substantially planar outer surface.

2. The recording medium of claim 1 wherein the magnetic elements comprise nanowires or nanotubes coated with magnetic material.

3. The recording medium of claim 1 wherein the magnetic elements comprise nanotubes filled with magnetic material.

4. The recording medium of claim 1 wherein the magnetic elements are substantially parallel and the planar outer surface is substantially perpendicular to the magnetic elements.

5. The recording medium of claim 1 wherein the magnetic elements are disposed in a substantially regular array.

6. The method of making a high density magnetic recording medium comprising the steps of:
providing a substrate supporting a plurality of magnetic elements comprising nanowires or nanotubes, the elements disposed substantially parallel and substantially perpendicular to the substrate with spaces between the elements;
filling the spaces between the elements with non-magnetic filler material; and
planarizing the filler material to form a planar surface substantially perpendicular to the elements.

7. The method of claim 6 wherein the providing step includes coating nanowires or nanotubes with magnetic material.

8. The method of claim 7 wherein the coating comprises inclined angle physical vapor deposition.

9. The method of claim 7 wherein the coating comprises chemical vapor deposition.

10. The method of claim 7 wherein the coating comprises growing nanotubes filled with magnetic material.

11. The method of claim 7 wherein the planarizing comprises mechanical polishing or chemical mechanical polishing.

12. A method of making a high density magnetic recording medium comprising the steps of:
providing a substrate;
forming on the substrate a plurality of spaced nuclei comprising magnetic material;
growing vertically aligned nanomagnets from the nuclei;
filling the space between the nanomagnets with nonmagnetic filler material; and
planarizing the filler material.

13. A method of making a high density magnetic recording medium comprising the steps of:
providing an oxidizable metal substrate having a plurality of oxidizable magnetic elements disposed thereon, the metal substrate more easily reduced than the magnetic elements;
oxidizing surface coatings on the substrate and the elements;
reducing the coating on the substrate without completely reducing the coating on the elements; and
electroplating filler material onto the substrate between the elements.

14. A method of making a high density magnetic recording medium comprising the steps of:
providing a mixture of solidifiable viscous material and nanometer scale superparamagnetic particles;
subjecting the mixture to a magnetic field to align the particles in parallel chains; and
solidifying the various material.

15. A method of making a high density magnetic recording medium comprising the steps of:
forming a body of phase separated material comprising ferromagnetic phase regions within a nonmagnetic matrix;
deforming the body to elongate and reduce the longitudinal size of the ferromagnetic phase regions;
transversely separating sections of the elongated deformed body.

16. A method of making a high density magnetic recording medium comprising the steps of:
providing a high density recording medium according to claim 1; and
selectively etching the exposed magnetic elements so they are recessed with respect to the planar surface.

17. A method of making a high density magnetic recording medium comprising the steps of:
providing a high density recording medium according to claim 1; and
selectively growing the exposed magnetic elements so they protrude with respect to the planar surface.

18. A method of making a high density topographic recording comprising the steps of:
providing a recording medium comprising an array of elongated nanoscale elements of a first material embedded in a matrix of a second material; and
selectively etching a pattern of the exposed elements to record information corresponding to the pattern.

19. A method of making a high density topographic recording comprising the steps of:
providing a recording medium comprising an array of elongated nanoscale elements of a first material embedded in a matrix of a second material; and
selectively growing a pattern of the exposed elements to record information corresponding to the pattern.
